(19) United States
(12) Patent Application Publication
(10) Pub. No.: US 2005/0188675 A1
(43) Pub. Date: Sep. 1, 2005

(54) Rotary engine

(76) Inventor: Jung Kuang Chou, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/114,059

(22) Filed: Apr. 26, 2005

Related U.S. Application Data
(63) Continuation-in-part of application No. 10/900,192, filed on Jul. 28, 2004.
Application No. 10/900,192 is a continuation-in-part of application No. 10/392,859, filed on Mar. 21, 2003, now abandoned.

(51) Int. Cl. F02C 3/00

(52) U.S. Cl. 60/39.44

(57) ABSTRACT

A rotary engine includes a round wheel, which has a shaft pivoted on a frame to provide kinetic force during rotating, wherein the round wheel is provided with a plurality of pockets. At least one block is located at a lateral side or round surface of the wheel, which keeps stable contact with the round surface of the wheel by use of elastic force provided by a spring mounted on a screw and provides a suitable oblique angle between the block and the wheel. The block has an aperture, a combustion chamber, and a power room, which are opposite to pockets of the wheel to form quasi cylinders. A roller is fixed on the frame to support and maintain the block in stable. Acting force, which can be produced when mixture fuel is input into the pocket, when the fuel is ignited and exploded in the combustion chamber, and when expansion gas is exhausted into the power room, pushes the wheel to rotate continuously for outputting efficient kinetic force for utilization.

This application is a continuation-in-part of U.S. application Ser. No. 10/900,192 filed on 28 Jul. 2004 being a continuation-in-part of U.S. application Ser. No. 10/392,859 filed on 21 Mar. 2003, which had claimed priority on Taiwanese application filed on 3 Apr. 2002.

### FIELD OF THE INVENTION

The present invention relates to a rotary engine, and especially to an invented and novel apparatus having absolute new structure for providing continuous horsepower as an efficient engine.

### BACKGROUND OF THE INVENTION

There are various kinds of engines for providing kinetic force in different mechanic apparatus. Each engine is designed for a certain purpose in utilizing a related machine with a specific way to supply the horsepower. It is popular that most land vehicles use reciprocating piston engines, which are characterized in that their torques are normal in low rotating speed. The known reciprocating piston engine generally must have a suitable clearance between the piston and the cylinder thereof for rotation, thereby, it should be cooled to be controlled at the state of low-temperature rotation to prevent from strain by expansion and contracting by heating and cooling, the total heat consumption thereof is about 60% of the total amount of fuel, and the effective rate of use is only about 30%.

Further, an intermittent intake system is not easy in controlling the mixture ratio of air with fuel, a low combustion temperature is subject to air contamination, and each time the cylinder has a larger explosion amount, higher noise, larger vibration, more complicated control, and relatively, its structure is heavier, bigger and more consolidated. By virtue that explosion has some limitations, the internal diameter of the cylinder is perfectly not larger than 15 cm; hence a gasoline engine with larger horsepower mostly is composed of multiple cylinders, the performance of acceleration of it is inferior, it is added with mixed gas once every one or two turns of rotation, the amount that can be added is limited, and is hard to elevate the combustion temperature for increasing efficiency.

### SUMMARY OF THE INVENTION

The present invention is to provide a rotary engine getting rid of the limitation of a conventional piston engine, which can avoid the defects of the limitation by the low temperature rotation, the intermittent gas intake and discharging to elevate the combustion temperature for increasing efficiency.

A character of the present invention is to solve the problem of thermal expansion in the engine, wherein it can keep the pressure and friction between the block and the wheel approach to zero in order to reduce the force of resistance and to increase its horsepower. The effect is composed of the block and the point of the support, between which a suitable angle is formed relating to the round wheel, which can be supported by a roller.

According to the principal theory of combustion, the traditional method uses low-density mixture gases, wherein the distance between each oil molecule is far that is difficult for being ignited. It should be compressed to a volume about one over nine ( 1/9) to increase the temperature of the mixture fuel, while the oil molecules are so close to be ignited by each other at 300 degree centigrade for explosion. The present invention uses an input mixture fuel, which is continuously burn to get high pressure and temperature that obtains efficient combustion with quick reaction and will be available as using various fuels, wherein the conditions of compressed ratio, air density, and oil ratio are not so important, whatever the air should be offered sufficiently.

Now, accompanying with the following drawings, the character of the present invention will be described here and after.

### BRIEF DESCRIPTION OF THE DRAWINGS

FIG. 1 is a perspective view showing a rotary engine according to the present invention.

FIG. 2 is an exploded perspective view of FIG. 1 showing parts of the engine.

FIG. 3 is a cross-sectional plan view showing the contact plane of FIG. 2.

FIG. 4 is a top cross-sectional plan view of FIG. 1.

FIGS. 5 to 9 are views of FIG. 4 showing the acting processes according to the present invention.

FIG. 7-1 is an enlarged view of a part of FIG. 7.

FIG. 10 is a cross-sectional plan view showing a modified embodiment according to the present invention.

FIG. 11 is a perspective view showing an exemplary embodiment of FIG. 10.

### DETAILED DESCRIPTION OF THE PREFERRED EMBODIMENT

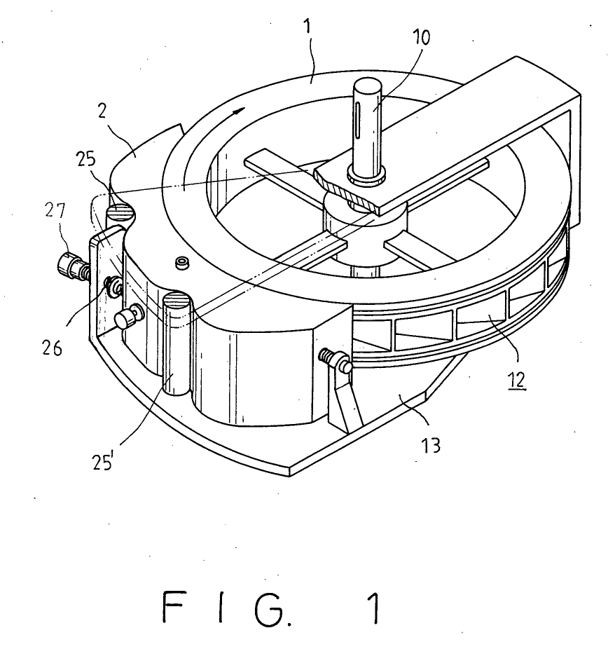

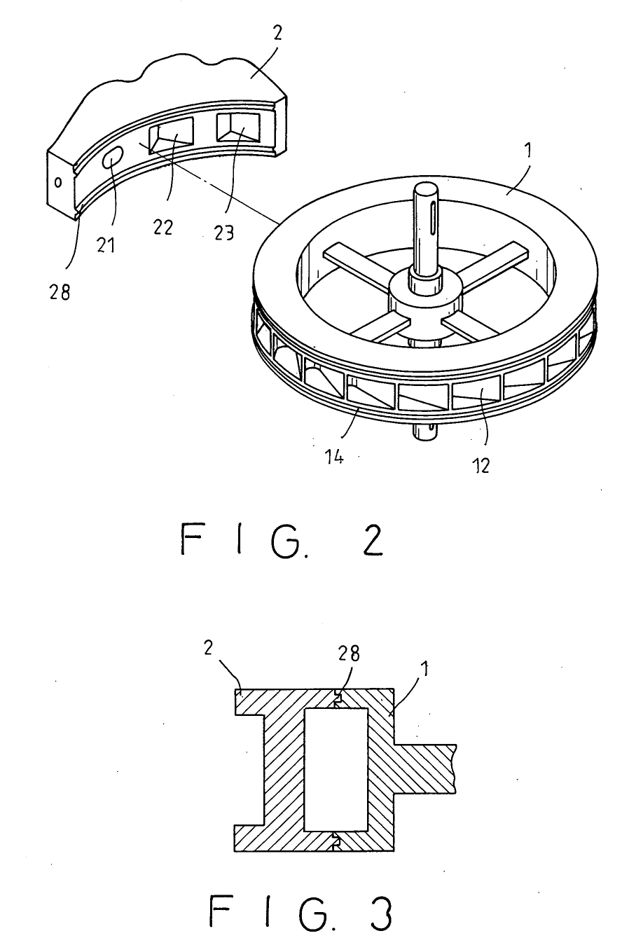

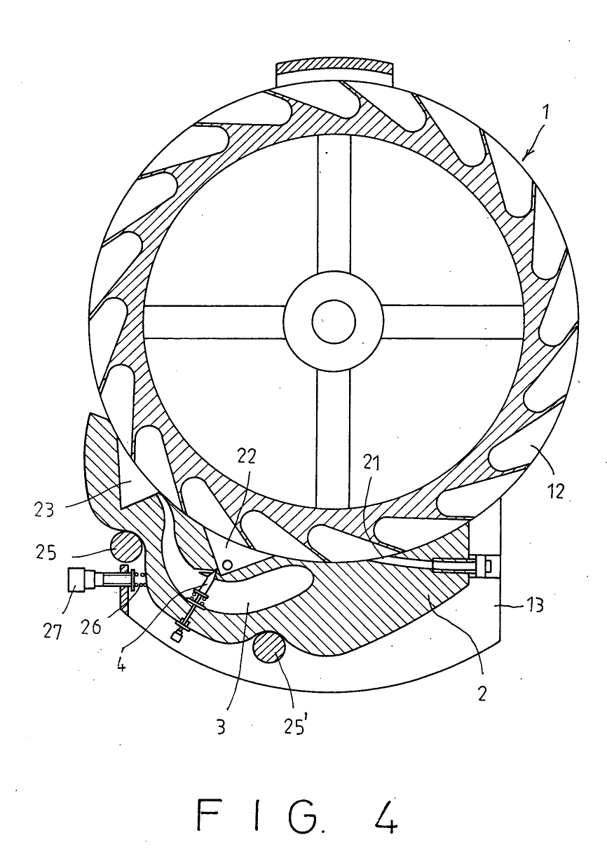

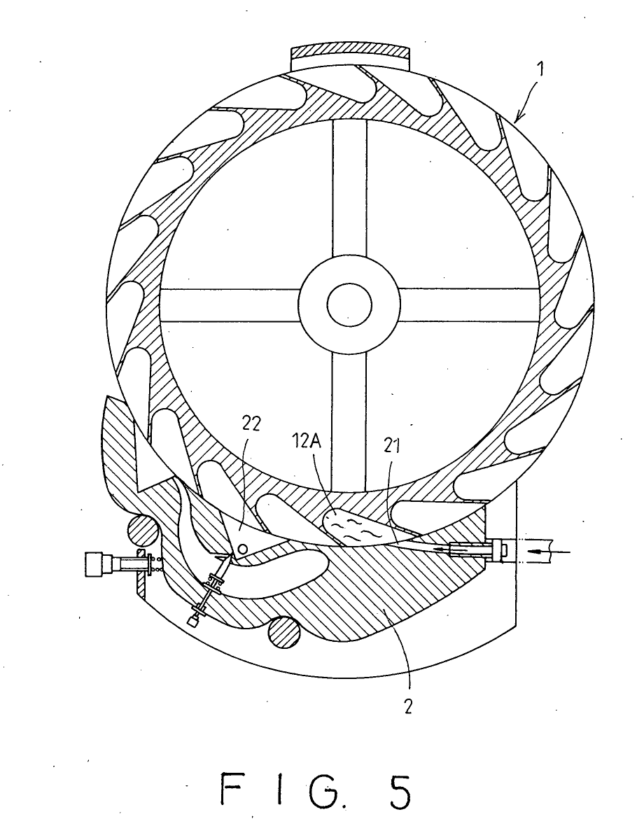

Please referring to FIG. 1 to 4, the present invention includes a round wheel (1), of which a shaft (10) is pivoted on a frame (13) to provide kinetic force during rotating. The round wheel (1) is provided with a plurality of pockets (12) being capable of any suitable configuration. At least one block (2) is located at a lateral side or round surface of the wheel (1) with a suitable oblique angle to keep stable contact with the round surface of the wheel (1) by use of elastic force provided by a spring (26) mounted on a screw (27) connected on the frame (13), wherein the block (2) is provided with a convex ring (28) for fitting with concave portion (14) formed on the wheel (1), as shown in FIGS. 2 and 3. The block (2) is also provided with an intake aperture (21), a combustion chamber (22), and a power room (23), which are opposite to pockets (12) of the wheel (1) to form quasi cylinders. A cooling room (3) provided in the block (2) has a released valve (4), which communicates with the combustion chamber (22) and is adjustable to control the released pressure. Two rollers (25) and (25′) are provided on the frame (13) to support and maintain the block (2) in stable, wherein the second roller (25′) can be moveable by connecting an elastic apparatus inside (not shown).

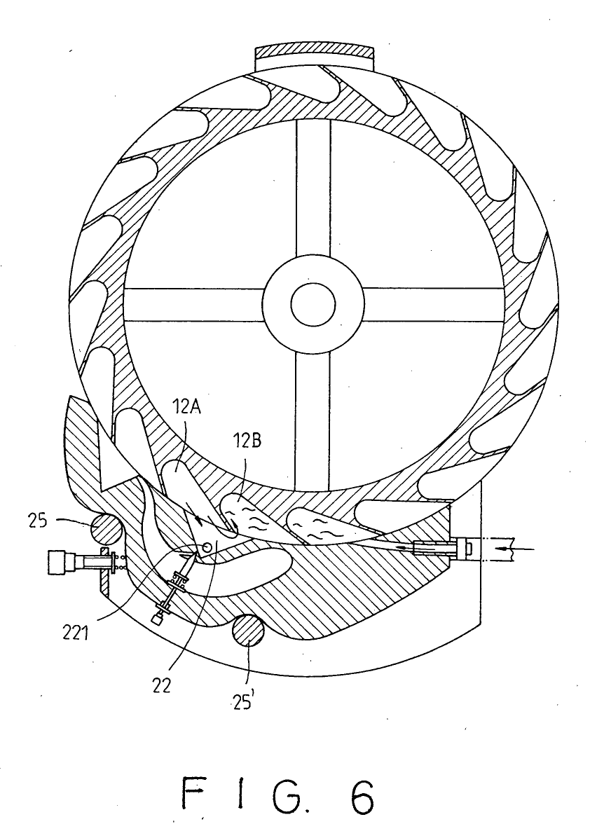

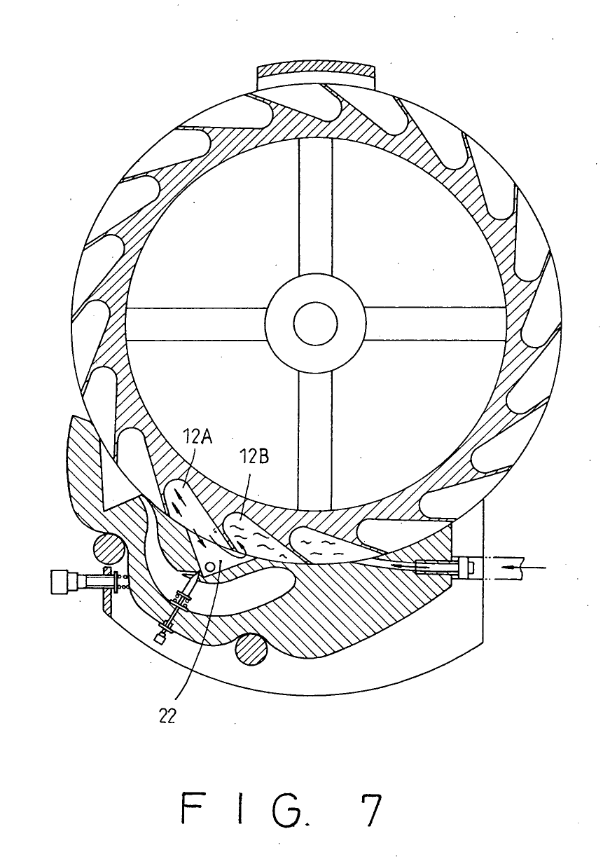

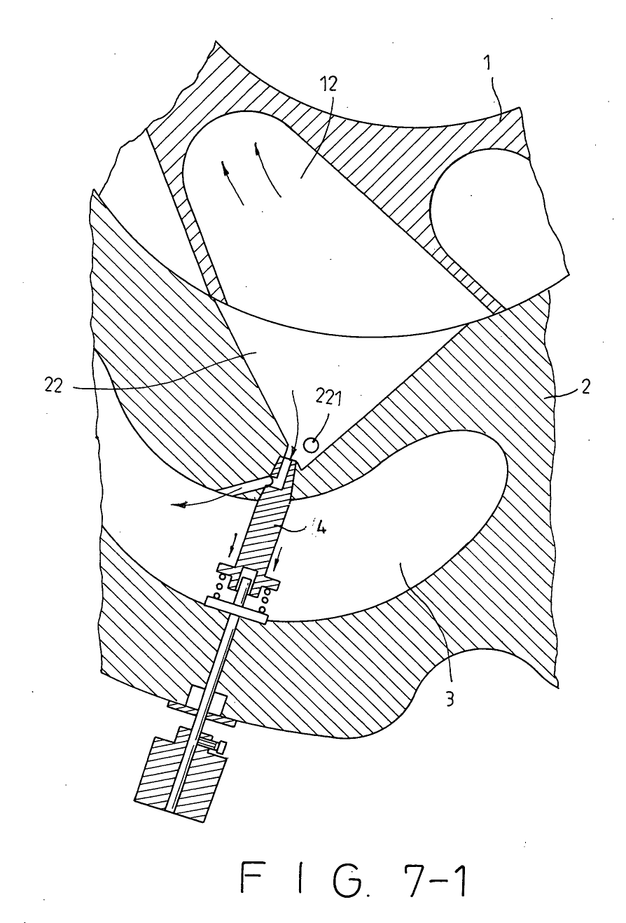

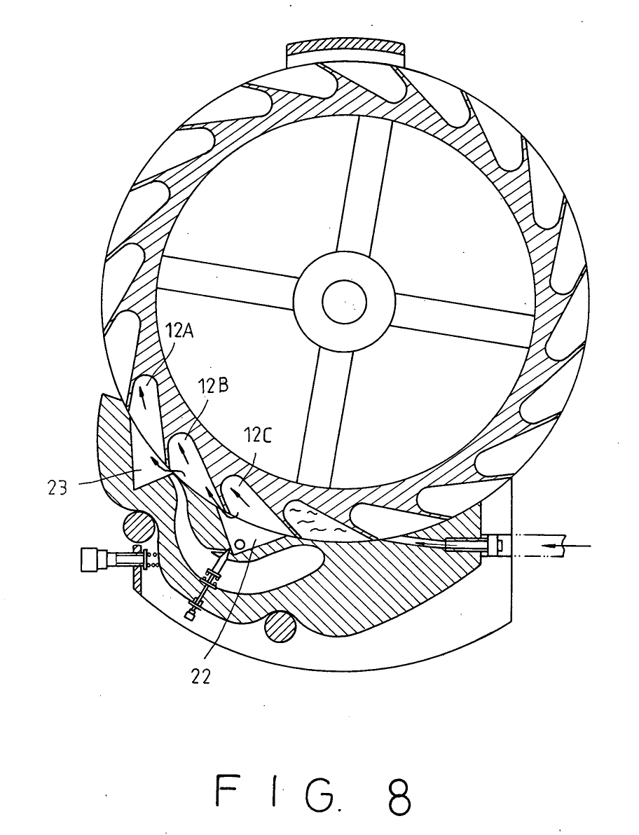

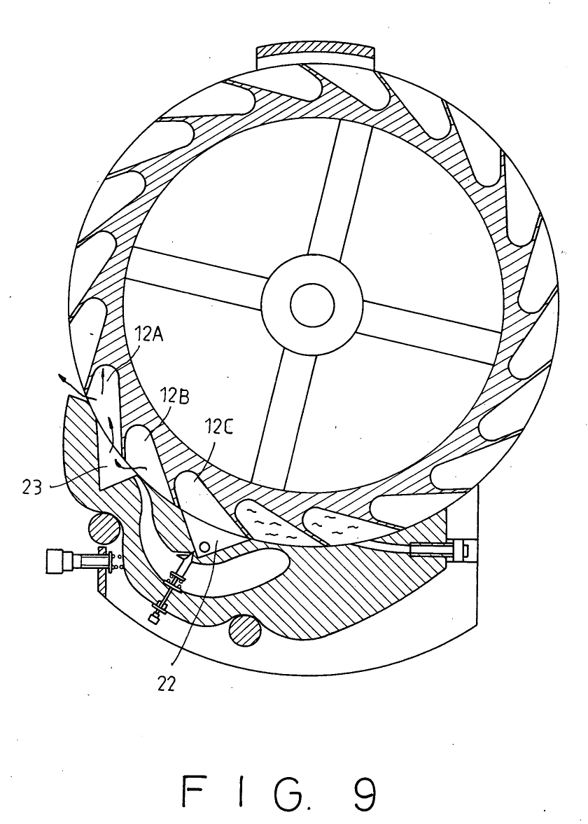

In processing, when high-pressured mixed fuel is input from the intake aperture (21) into a related pocket (12A), as shown in FIG. 5, a pressure of the direct flow can motivate the wheel (1) to start rotating that provides an initial acting force (or a known motor starter equipment is able to cause this action, not shown). As the said leading pocket (12A) with mixed fuel moves to communicate with the combustion chamber (22), the fuel will be ignited quickly by a spark plug (221) provided thereof. An explosion is occurred and an expansion force will be produced, wherein the airflow including CO2 and steam to keep combustion chamber (22) and the leading pocket (12A) in high temperature and pressure. When the tracer pocket (12B) moves to communicate with the combustion chamber (22), the high-pressured mixture fuel will flow, as arrowed mark from FIG. 6 to 7, while the fuel therein will also be ignited quickly. Since the block (2) is kept in stable by the first roller (25), the burning gases in high pressure and temperature will be backfire to impulse the capacity of the tracer pocket (12B) and then forward into the combustion chamber (22) as well as the leading pocket (12A) to motivate the wheel (1) rotating because it is the easy direction for releasing the pressure of the explosion gases. The gases in the space can be expansion in volume and reduced in pressure so that it is not a closed status. Furthermore, accompanying with FIG. 8, as the leading pocket (12A) is moved to the communicated position with the power room (23), the explosion gases will then exhausts therein in pressure. Meanwhile, the explosion stroke therein will be similar to a conventional cylinder performance. In order to release this high-pressured gases, the wheel (1) is going to rotate continuously until it is exhausted from the opening between the block (2) and the leading pocket (12A) that becomes therefore a pushing to the wheel (1) to rotate and provides a second power supply. During this action, it can be found that the tracer pocket (12B) is apart from the power room (23), where is going to make a next procedure for providing next pushing power. In other words, it becomes an exchange status between the movement of the pockets and the power room (23). As the tracer pocket (12B) is open to the power room (23) at first moment, the leading pocket (12A) is closed for gaining the high-pressured gases from the tracer pocket (12B) or following pocket (12C) for work (FIG. 8). Then, the high-pressured gases in the pockets can provide enough power to push the wheel rotating until released. And when the leading pocket (12A) is open to outside, the following pocket (12C) is closed relating to the power room (23). Thus, the power room (23) obtains a closing-opening exchange status that provides strong horsepower. Meanwhile, please refer to FIG. 7-1, if the pressure is too high in the combustion chamber (22), the explosion gases can be released from the valve (4), which is formed and is capable of adjusting its control pressure between the chamber (22) and the cooling room (3), while this released gas is guided to flow into power room (23) to push the pocket of the wheel (1) to rotate and then the gases will be released out. It can be understood that by use of said repeated processes of explosion, the wheel (1) rotates and outputs the continuous kinetic force for utilization efficiently. And by virtue that the combustion keeps in high temperature, it can get the same effect when in a lower ratio of compression; but the rotation speed of the engine is smaller, the ratio of compression can be changed to adjust the rotation speed.

In order to prove the possibility of the present invention, we are going to explain in detail the principle of power and motion in the embodiment, which is not a closed status. Due to the distance between the combustion chamber (22) and the power room (23) is larger than the opening of each pocket (12); the high-pressured gases stayed in the combustion chamber (22) will be expanded into a leading pocket or a tracer pocket after combustion that provides an expansion force. In this area, three directions are almost fixed and one easy direction is movable for expansion gases to be released its pressure. This movement and force thus push the wheel (1) to rotate. As the leading pocket (12A) is moved to the power room (23), the high-pressured gas is exhausted therein that also transfers to a mechanical power to push the wheel rotating as a second output force. Therefore, the wheel (1) is continuously moved and rotated to produce kinetic force for use with no doubt.

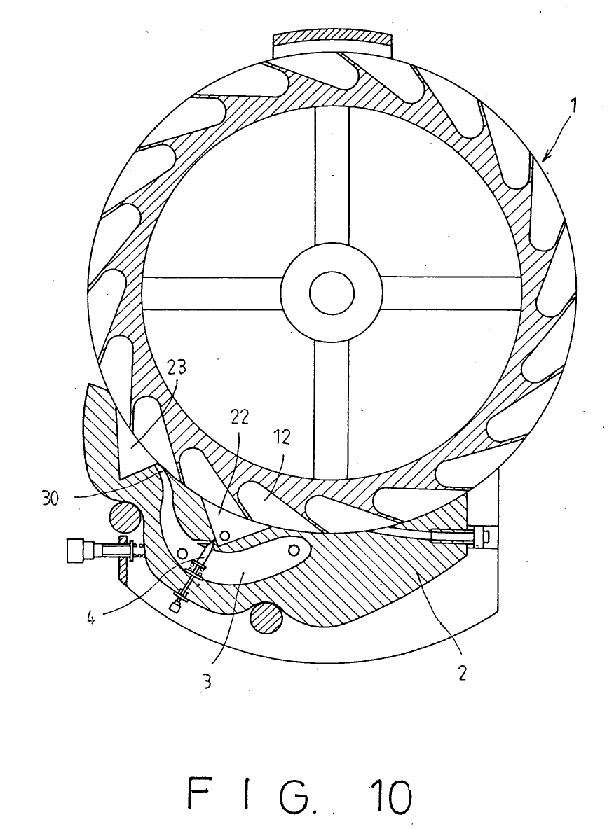

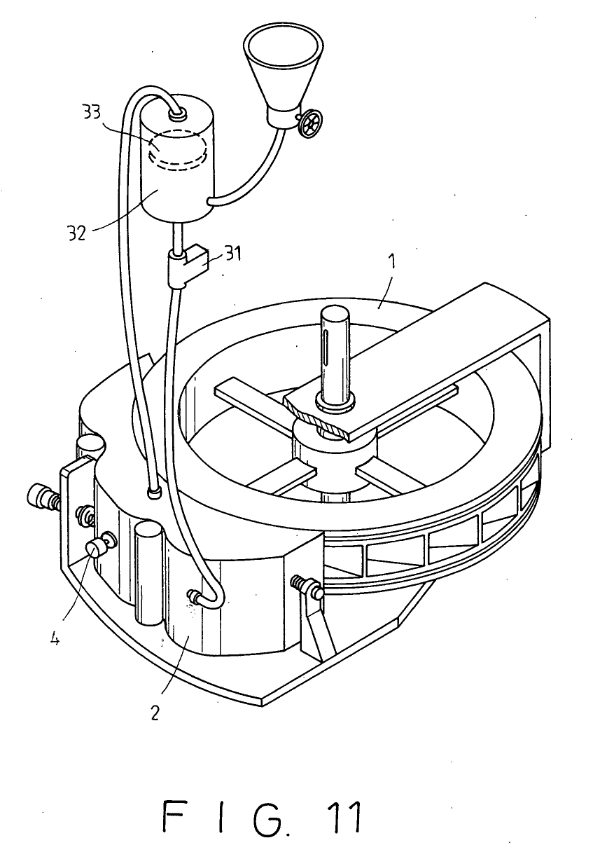

Please referring to FIGS. 10 and 11, they show the views of another modified embodiment of a rotary engine according to present invention, wherein a temperature controller (not shown) can be provided in the cooling room (3) for controlling an electrical valve (31) to spray water from a tank (32) into the cooling room (3) when the temperature in the cooling room (3) reaches to a presetting degree. A metal float (33) can be placed in the tank (32) floating on the water to provide enough pressure for spraying water into the room (3) as the valve (31) is opened. Then the cooling water becomes steam after cooling the combustion chamber (22) and the steam can be sprayed from its outlet vent (30) into the power room (23) to push a relating pocket that facilitates the rotation of the wheel.

In conclusion, the present invention discloses a rotary engine to get rid of the drawbacks resided in a conventional engine and to elevate the combustion temperature for increasing efficiency of the rotary engine that is novel and utilizable.

The embodiment described is only for illustrating the present invention, it will be apparent to those skilled in this art that various modifications or changes without departing from the spirit of this invention shall also fall within the scope of the appended claims.

1. A rotary engine including a round wheel having a shaft pivoted on a frame to provide kinetic force during rotating, wherein the round wheel being provided with a plurality of pockets, and at least one block being located at a lateral side or round surface of the wheel being kept stable contact with the round surface of the wheel by use of elastic force provided by a spring connected on a screw mounted on the frame, wherein the block is placed its external with a suitable oblique angle relating to the round wheel and is supported by a roller being fixed on the frame to support and maintain the block in stable, and the block having an intake aperture, a combustion chamber, and a power room, which are opposite to pockets of the wheel to form quasi cylinders, and a cooling room being formed in the block with a valve being capable of adjusting control pressure communicating with the combustion chamber; action forces to the pockets and wheel for rotating being produced by use of the high-pressured injected mixture fuel from intake aperture, the mixture fuel being ignited in the combustion chamber, and producing the high-pressured gases exhausted into the power room to push the pocket of the wheel rotating for output kinetic force.

2. The rotary engine as claimed in claim 1, wherein the block is provided with a temperature controller in the cooling room for controlling an electrical valve to spray water from a tank into the cooling room as the temperature in the room reaches to a presetting degree, and the cooling water becoming steam after cooling the combustion chamber and being sprayed from its outlet vent into the power room to push a relating a pocket that facilitates the rotation of the wheel.

3. The rotary engine as claimed in claim 1, wherein the block is provided with a cooling room around the combustion chamber, an valve is provided in the cooling room and is adjustable in control pressure to communicate with the combustion chamber for releasing extra pressure through cooling room into power room when the explosion occurs too much expansion gases, which is necessary to be released that provides an added motive force for the wheel to rotate.

4. The rotary engine as claimed in claim 1, wherein the movement of the pocket and the power room becomes an exchange status, as the tracer pocket is open to the power room at first moment, the leading pocket be closed to gain the high-pressured gases from the tracer pocket and following pocket for work, and as the leading pocket is open to outside, the following pocket is closed relating to the power room that the power room obtains a closing-opening exchange status.
